(19) United States
(12) Patent Application Publication
(10) Pub. No.: US 2025/0202527 A1
(43) Pub. Date: Jun. 19, 2025

(54) POWER ALLOCATION IN A DATA AND POWER NETWORK

(71) Applicant: GENETEC INC., Saint-Laurent (CA)

(72) Inventor: JEAN-YVES PIKULIK, Saint-Laurent (CA)

(21) Appl. No.: 18/849,566

(22) PCT Filed: Mar. 24, 2023
(86) PCT No.: PCT/CA2023/050398

§ 371 Date: Sep. 23, 2024

Related U.S. Application Data
(60) Provisional application No. 63/323,686, filed on Mar. 25, 2022.
(60) Provisional application No. 63/323,386, filed on Mar. 24, 2022.

(51) Int. Cl. H04B 3/54

(52) U.S. Cl. CPC H04B 3/544; H04B 3/546

(57) ABSTRACT

A method and an apparatus for allocating power to a given downstream device of at least one downstream device that is included in a data and power network (DPN). The method comprises: ascertaining a given role for the given downstream device, wherein the given role corresponds to a function within the DPN that has been selectively associated with the given downstream device; allocating an amount of power to the given downstream device by applying a role-based power allocation policy; and causing the allocated amount of power to be distributed to the given downstream device.

### CROSS-REFERENCE TO RELATED APPLICATIONS

The present application claims the benefit of U.S. Provisional Application Ser. No. 63/323,386 filed on Mar. 24, 2022 and U.S. Provisional Application Ser. No. 63/323,686 filed on Mar. 25, 2022, both hereby incorporated by reference herein.

### FIELD

The present disclosure relates generally to power allocation and, more particularly, to a method and apparatus for allocating power in a data and power network (DPN).

### BACKGROUND

To accelerate the deployment of connected devices requiring an external source of power, there has been a move to adapt existing data infrastructures so as to allow devices to be powered using data lines. As a result, technologies have been developed for carrying power and data over the same physical lines, an example being Power-over-Ethernet (POE) technology.

Originally, PoE technology only provided for a single leg in power transmission from a power source equipment (PSE, such as a PoE router) to a powered device (PD, also known as power consuming equipment (PCE)). Later, technologies such as those taught in U.S. patent application Ser. No. 16/688,563 were developed to extract power by an intermediary device located between the PSE and the PD. Additionally, technologies such as those taught in U.S. patent application Ser. No. 16/879,631 and U.S. patent application Ser. No. 17/211,404 were developed for more complex power sharing over multiple devices in a data and power network (DPN). All these prior patent applications are hereby incorporated by reference herein in their entirety.

As the complexity of data and power networks (DPNs) grows, so too does the need for power management. Conventionally, a PSE may prioritize the allocation of power to its subtending PCEs based on a device type of each PCE; however, this solution may result in poor functionality from the point of view of an administrator who manages the DPN. For example, in a PDN that prioritizes power allocation based on device type and includes PCEs that are considered either as “light” device type or as “camera” device type, all PCEs considered as “light” device type would be treated the same, and all PCEs considered as “camera” device type would be treated the same. In the event that there is enough power to run all the PCEs considered as “light” device type or all the PCEs considered as “camera” device type, but not both, then prioritizing one device type over the other would mean that all lights would run and all cameras would be turned off, or vice versa. Such an outcome might be undesirable from the administrator's point of view.

Alternatively, hard-coding which devices should be prioritized on an individual basis also has drawbacks, with such a solution having reduced flexibility and increased complexity from a power management standpoint.

In view of the foregoing, an improvement in intelligently and dynamically allocating power to PCEs in a PDN would be desirable.

### SUMMARY

According to a first example aspect, there is provided a method for allocating power to a given downstream device of at least one downstream device. The method is performed at an upstream device of a data and power network (DPN) that includes the at least one downstream device. The method comprises: ascertaining a given role for the given downstream device, wherein the given role corresponds to a function within the DPN that has been selectively associated with the given downstream device; allocating an amount of power to the given downstream device by applying a role-based power allocation policy; and causing the allocated amount of power to be distributed to the given downstream device.

In accordance with any of the preceding aspects, the role-based power allocation policy may define a collection of rules for prioritizing a plurality of roles and a power allocation algorithm, the plurality of roles including the given role.

In accordance with any of the preceding aspects, the collection of rules may specify a hard-coded prioritization of the roles.

In accordance with any of the preceding aspects, the collection of rules may specify constraints for prioritization of the roles relative to one another.

In accordance with any of the preceding aspects, the collection of rules may specify at least one contextual factor on which prioritization of the roles depends.

In accordance with any of the preceding aspects, the at least one contextual factor may include a temporal factor.

In accordance with any of the preceding aspects, the at least one contextual factor may include sensed data.

In accordance with any of the preceding aspects, further comprising retrieving the role-based power allocation policy from a non-transitory memory of the upstream device.

In accordance with any of the preceding aspects, further comprising receiving the role-based power allocation policy from another device in the DPN via a policy discovery protocol.

In accordance with any of the preceding aspects, applying the role-based power allocation policy may comprise prioritizing the plurality of roles in accordance with the collection of rules and carrying out the power allocation algorithm based on power needs of the given downstream device and on the plurality of roles as prioritized.

In accordance with any of the preceding aspects, further comprising determining the power needs of the given downstream device.

In accordance with any of the preceding aspects, further comprising ascertaining a device type of the given downstream device, the device type may differ from the given role, and determining the power needs of the given downstream device may be based on at least the device type.

In accordance with any of the preceding aspects, the device type may correspond to a predetermined behavior of the given downstream device independent of the DPN.

In accordance with any of the preceding aspects, the given role for the given downstream device may be different from a role for another downstream device having the same device type as the device type of the given downstream device.

In accordance with any of the preceding aspects, ascertaining the device type of the given downstream device may comprise determining a device identifier (ID) associated with the given downstream device and consulting a table stored in non-transitory memory, based on the device ID.

In accordance with any of the preceding aspects, ascertaining the given role for the given downstream device may comprise consulting a table stored in non-transitory memory based on the device ID associated with the given downstream device.

In accordance with any of the preceding aspects, the given role for the given downstream device may be independent of the device type of the given downstream device.

In accordance with any of the preceding aspects, the given role for the given downstream device may be set by an administrator of the DPN.

In accordance with any of the preceding aspects, ascertaining the given role for the given downstream device may be based on at least one contextual factor.

In accordance with any of the preceding aspects, the given role for the given downstream device may be selected form a plurality of potential roles based on the at least one contextual factor.

In accordance with any of the preceding aspects, the ascertaining a given role for the given downstream device may comprise: determining a plurality of potential roles associated with given downstream device; determining a contextual factor associated with the given downstream device; and selecting the given role as a current role amongst the plurality of potential roles based on the determined contextual factor.

In accordance with any of the preceding aspects, further comprising: receiving a power request from the given downstream device.

In accordance with any of the preceding aspects, further comprising: determining if the power request includes an indicator that the given downstream device is in a power domain, wherein the power domain is managed by a power sourcing device which has capability to make power allocation decisions; and in response to the power request including the indicator, skipping allocating the amount of power to the given downstream device.

In accordance with any of the preceding aspects, further comprising: determining that the given downstream device has the ability to implement the role-based power allocation policy to allocate power to one or more devices in a downstream direction of the given downstream device; obtaining respective minimum operating power of each of the one or more devices in the downstream direction of the given downstream device and minimum operating power for the given downstream device; and allocating total minimum operating power to the given downstream device to enable the given downstream device to implement the role-based power allocation policy.

In accordance with any of the preceding aspects, further comprising: determining that power available to the upstream device is insufficient to meet power needs of the at least one downstream device.

In accordance with any of the preceding aspects, the role-based power allocation policy may be pre-set by an administrator.

In accordance with any of the preceding aspects, the upstream device may be a power sourcing equipment (PSE).

In accordance with any of the preceding aspects, the upstream device may be a power consuming equipment (PCE) and the method may further comprise: sending a power request to a legacy power sourcing equipment (PSE), the power request may indicate that an amount of power is required from the legacy PSE to power the at least one downstream device; and receiving the power from the legacy PSE.

In accordance with any of the preceding aspects, the role-based power allocation policy may include at least a first sub-policy that defines a first collection of rules for a first contextual factor, a second sub-policy that defines a second collection of rules for a second contextual factor, and a metarule governing when each of the first sub-policy and the second sub-policy applies.

According to a second example aspect is a method for allocating power to a device of a data and power network (DPN). The method comprises: determining a device type of the device, wherein the device type corresponds to a fixed behavior of the device independent of the DPN; determining a role for the device, wherein the role corresponds to a function within the DPN that has been selectively associated with the device; determining power needs of the device based on at least the device type; allocating an amount of power to the device based on at least the role and the power needs; and causing the allocated amount of power to be distributed to the device via the DPN.

According to a third example aspect is an upstream device of a data and power network (DPN) that includes at least one downstream device, which is configured to allocate power to a given downstream device of the at least one downstream device. The upstream device comprises: a non-transitory memory comprising instructions; and one or more processors in communication with the memory, wherein the one or more processors execute the instructions to: ascertain a given role for the given downstream device, wherein the given role corresponds to a function within the DPN that has been selectively associated with the given downstream device; allocate an amount of power to the given downstream device by applying a role-based power allocation policy; and cause the allocated amount of power to be distributed to the given downstream device.

In accordance with any of the preceding aspects, the role-based power allocation policy may define a collection of rules for prioritizing a plurality of roles and a power allocation algorithm, the plurality of roles including the given role.

In accordance with any of the preceding aspects, the collection of rules may specify a hard-coded prioritization of the roles.

In accordance with any of the preceding aspects, the collection of rules may specify constraints for prioritization of the roles relative to one another.

In accordance with any of the preceding aspects, the collection of rules may specify at least one contextual factor on which prioritization of the roles depends.

In accordance with any of the preceding aspects, the at least one contextual factor may include a temporal factor.

In accordance with any of the preceding aspects, the at least one contextual factor may include sensed data.

In accordance with any of the preceding aspects, the instructions may be further executed to: retrieve the role-based power allocation policy from the non-transitory memory of the upstream device.

In accordance with any of the preceding aspects, the instructions may be further executed to: receive the role-based power allocation policy from another device in the DPN via a policy discovery protocol.

In accordance with any of the preceding aspects, applying the role-based power allocation policy may comprise prioritizing the plurality of roles in accordance with the collection of rules and carrying out the power allocation algorithm based on power needs of the given downstream device and on the plurality of roles as prioritized.

In accordance with any of the preceding aspects, the instructions may be further executed to: determine the power needs of the given downstream device.

In accordance with any of the preceding aspects, the instructions may be further executed to: ascertain a device type of the given downstream device, the device type may differ from the given role, and determining the power needs of the given downstream device may be based on at least the device type.

In accordance with any of the preceding aspects, the device type may correspond to a predetermined behavior of the given downstream device independent of the DPN.

In accordance with any of the preceding aspects, the given role for the given downstream device may be different from a role for another downstream device having the same device type as the device type of the given downstream device.

In accordance with any of the preceding aspects, the device type of the given downstream device may be ascertained by: determining a device identifier (ID) associated with the given downstream device and consulting a table stored in non-transitory memory, based on the device ID.

In accordance with any of the preceding aspects, the given role for the given downstream device may be ascertained by: consulting a table stored in non-transitory memory based on the device ID associated with the given downstream device.

In accordance with any of the preceding aspects, the given role for the given downstream device may be independent of the device type of the given downstream device.

In accordance with any of the preceding aspects, the given role for the given downstream device may be set by an administrator of the DPN.

In accordance with any of the preceding aspects, ascertaining the given role for the given downstream device may be based on at least one contextual factor.

In accordance with any of the preceding aspects, the given role for the given downstream device may be selected form a plurality of potential roles based on the at least one contextual factor.

In accordance with any of the preceding aspects, the given role for the given downstream device may be ascertained by: determining a plurality of potential roles associated with given downstream device; determining a contextual factor associated with the given downstream device; and selecting the given role as a current role amongst the plurality of potential roles based on the determined contextual factor.

In accordance with any of the preceding aspects,, the instructions may be further executed to: receive a power request from the given downstream device.

In accordance with any of the preceding aspects, the instructions may be further executed to: determine if the power request includes an indicator that the given downstream device is in a power domain, the power domain may be managed by a power sourcing device which has capability to make power allocation decisions; and in response to the power request including the indicator, skip allocating the amount of power to the given downstream device.

In accordance with any of the preceding aspects, the instructions may be further executed to: determine that the given downstream device has the ability to implement the role-based power allocation policy to allocate power to one or more devices in a downstream direction of the given downstream device; obtain respective minimum operating power of each of the one or more devices in the downstream direction of the given downstream device and minimum operating power for the given downstream device; and allocate total minimum operating power to the given downstream device to enable the given downstream device to implement the role-based power allocation policy.

In accordance with any of the preceding aspects, the instructions may be further executed to: determine that power available to the upstream device is insufficient to meet power needs of the at least one downstream device.

In accordance with any of the preceding aspects, the role-based power allocation policy may be pre-set by an administrator.

In accordance with any of the preceding aspects, the upstream device may be a power sourcing equipment (PSE).

In accordance with any of the preceding aspects, the upstream device may be a power consuming equipment (PCE) and the instructions is further executed to: send a power request to a legacy power sourcing equipment (PSE), the power request may indicate that an amount of power is required from the legacy PSE to power the at least one downstream device; and receive the power from the legacy PSE.

In accordance with any of the preceding aspects, the role-based power allocation policy may include at least a first sub-policy that defines a first collection of rules for a first contextual factor, a second sub-policy that defines a second collection of rules for a second contextual factor, and a metarule governing when each of the first sub-policy and the second sub-policy applies.

According to a third example aspect is an upstream device for allocating power to a device of a data and power network (DPN). The device comprises: a non-transitory memory comprising instructions; and one or more processors in communication with the memory, wherein the one or more processors execute the instructions to: determine a device type of the device, wherein the device type corresponds to a fixed behavior of the device independent of the DPN; determine a role for the device, wherein the role corresponds to a function within the DPN that has been selectively associated with the device; determine power needs of the device based on at least the device type; allocate an amount of power to the device based on at least the role and the power needs; and cause the allocated amount of power to be distributed to the device via the DPN.

According to a fourth example aspect is a non-transitory computer readable medium having instructions tangibly stored thereon, wherein the instructions, when executed, cause a system to perform any one of the method of claims disclosed above.

According to a fifth example aspect is a non-transitory computer readable medium having instructions tangibly stored thereon, wherein the instructions, when executed, cause a system to the method of claim disclosed above.

### BRIEF DESCRIPTION OF THE DRAWINGS

Reference will now be made, by way of example, to the accompanying drawings which show example embodiments of the present application, and in which:

FIGS. 1A and 1B are schematic diagrams of an example data and power network (DPN) in accordance with example embodiments;

FIGS. 2A and 2B are tables illustrating information pertaining to various devices stored by or accessed by a second generation (G2) device in the DPN of FIG. 1A or 1B;

FIG. 3A is a flowchart illustrating a method of allocating and distributing power in accordance with a non-limiting example embodiment, including a step of applying a role-based power allocation policy;

FIG. 3B is a flowchart illustrating sub-steps in the step of applying a role-based power allocation policy in FIG. 3A in accordance with an example embodiment, including prioritization of roles and a power allocation algorithm;

FIGS. 4A-4B is a flowchart illustrating implementation of the power allocation algorithm of FIG. 3B in accordance with an example embodiment;

FIG. 5A is a schematic diagram illustrating a network topology similar to that of FIG. 1A except where a G2 power sourcing equipment (PSE) replaces a first generation (G1) power consuming equipment (PCE);

FIG. 5B is a schematic diagram illustrating that a power request originating from a device in a downstream direction relative to a G2 PSE passes through the G2 PSE in the network topology of FIG. 5A;

FIG. 5C is a schematic diagram illustrating that a power request originating from a device in the downstream direction relative to a G2 PSE arrives at a G2 device in the network topology of FIG. 5A;

FIG. 6A is a schematic diagram illustrating a network topology similar to that of FIG. 1A except where a G2 PCE replaces a G1 PCE;

FIG. 6B is a schematic diagram illustrating implementation of a policy discovery protocol amongst G2 devices in the network topology of FIG. 6A;

FIGS. 7A and 7B are block diagrams of an example processing system that can be employed to implement certain embodiments, and

FIG. 8 is a flowchart illustrating a method of allocating and distributing power in accordance with an alternative non-limiting example embodiment.

Similar reference numerals may have been used in different figures to denote similar components.

In the drawings, embodiments are illustrated by way of example. It is to be expressly understood that the description and drawings are only for purposes of illustrating certain embodiments and are an aid for understanding. They are not intended to be a definition of the limits of the invention.

### DESCRIPTION OF EXAMPLE EMBODIMENTS

The present disclosure is made with reference to the accompanying drawings, in which certain embodiments are shown. However, the description should not be construed as limited to the embodiments set forth herein. Rather, these embodiments are provided as examples. Also, like numbers refer to like elements throughout. Separate boxes or illustrated separation of functional elements or modules of illustrated systems and devices does not necessarily require physical separation of such functions or modules, as communication between such elements can occur by way of messaging, function calls, shared memory space, and so on, without any such physical separation. As such, functions or modules need not be implemented in physically or logically separated platforms, although they are illustrated separately for ease of explanation herein. Different devices can have different designs, such that while some devices implement some functions in fixed function hardware, other devices can implement such functions in a programmable processor with code obtained from a machine-readable medium.

In a Power-over-Ethernet (POE) system, POE devices are able to receive and/or distribute both power and data over a same set of hybrid data and power links, such as Ethernet cables. A POE device may be a power sourcing equipment (PSE) or a power consuming equipment (PCE). The PSEs and PCEs can be interconnected in a variety of network topologies, for example including a mesh configuration, a daisy chain configuration, and so on, to form a data and power network (DPN).

Within a DPN having a given network topology, a PCE can be a first generation (G1) power consuming device, a second generation (G2) power consuming device, or legacy power consuming device:
(a) a legacy PCE has the ability to request power and consume power, but not distribute it. Examples of legacy PCEs include powered devices (PDs) such as cameras, illumination devices (i.e., lights), wireless access points, smoke detectors, speakers and the like;
(b) a G1 PCE has the ability to request power, consume power and distribute power based on received instructions, but does not have the ability to make policy-based allocation decisions about power distribution. An example of a G1 PCE is an intermediate device with power tapping ability, as disclosed in U.S. patent application Ser. No. 16/879,631, hereby incorporated by reference herein. The intermediate device may include at least one downstream port (also known as an external port) for connection with a downstream device and at least one dedicated device port (also known as an internal port) for connection to at least one dependent powered device. The dependent power device may include an illumination device, a camera, a smoke detector, and so on; and
(c) a G2 PCE has the ability to request power, consume power and distribute power based on received instructions (just like a G1 PCE), and also has the ability to make allocation decisions about power distribution based on a policy, such as a role-based policy. This will be described later on in this document in greater detail.

In respect of a PSE, the PSE can be a legacy power sourcing device or a G2 power sourcing device:
(a) a legacy PSE has the ability to respond to a request for an amount of power and to provide the requested amount of power, assuming that the requested amount of power is available and deliverable; and
(b) a G2 PSE combines the functionality of a G2 PCE and a power source. In other words, a G2 PSE has the ability to respond to the request to make policy-based allocation decisions about power distribution and, additionally, to provide or source the power needed to carry out the policy-based allocation decisions.

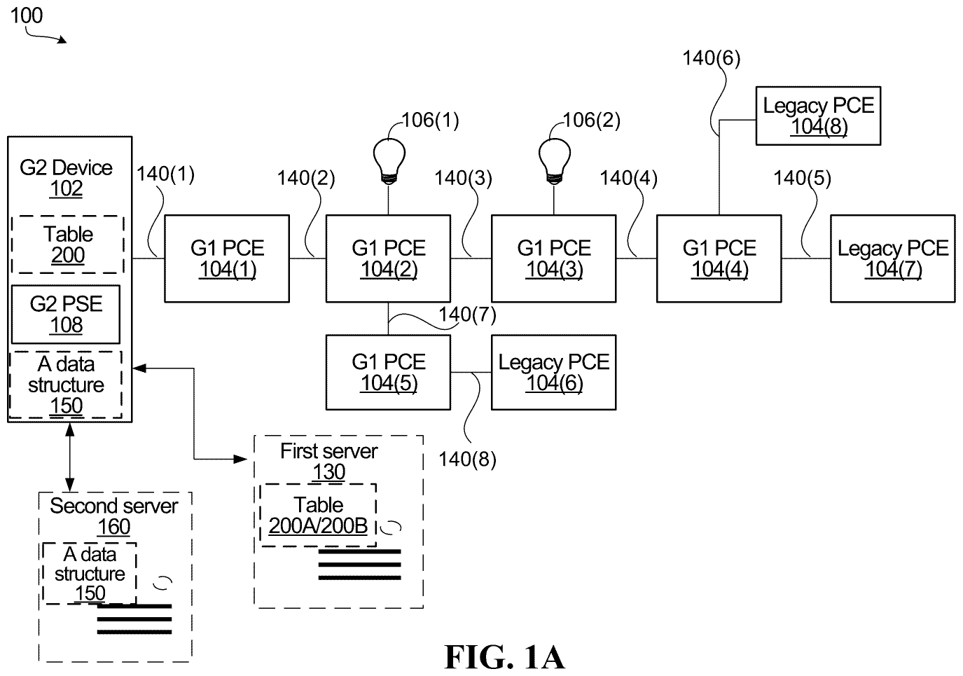

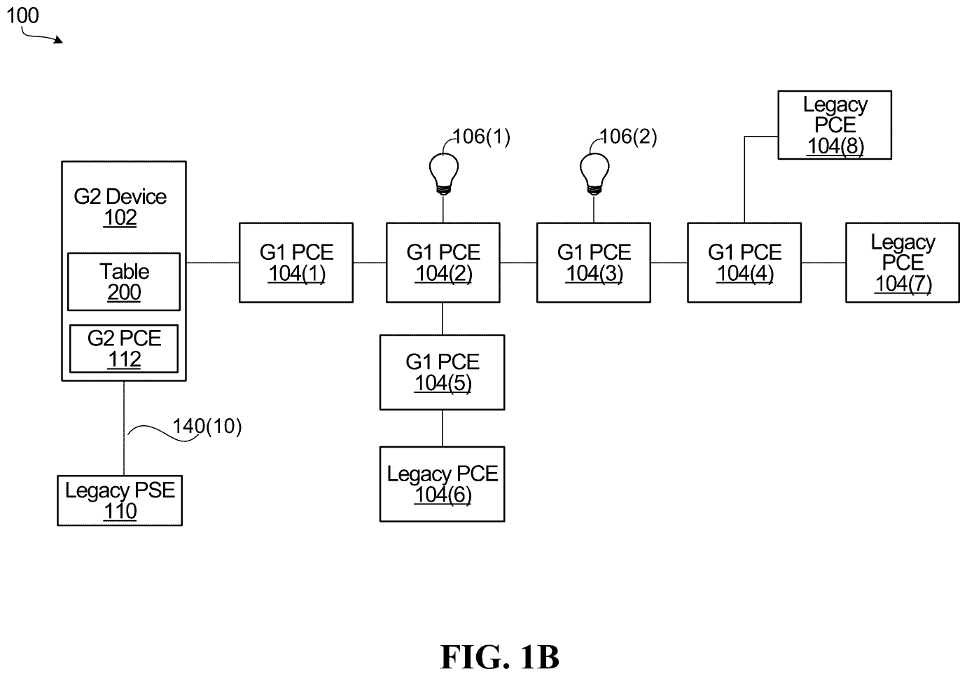

FIGS. 1A and 1B illustrate an example topology of a data and power network (DPN) 100 of a Power-over-Ethernet (POE) system which, in accordance with example embodiments, may be governed by a role-based power allocation policy (discussed in detail below). For ease of illustration, a single G2 device 102 is included in the DPN 100 having a simple network topology to implement a role-based power allocation policy. The DPN 100 as shown in FIGS. 1A and 1B has the same downstream device configuration. Where the DPN 100 in FIGS. 1A and 1B differ is that FIG. 1A shows that the G2 device 102 of the DPN 100 is a G2 PSE 108 to source power to downstream devices, whereas FIG. 1B shows that the G2 device 102 of the DPN 100 is a G2 PCE 112 that requests power and obtains power from a legacy PSE 110 further upstream. In either case, however, the G2 device 102 is a device that has the ability to implement a power allocation policy, such as a role-based power allocation policy (to be discussed below in great detail) in order to allocate and distribute power downstream.

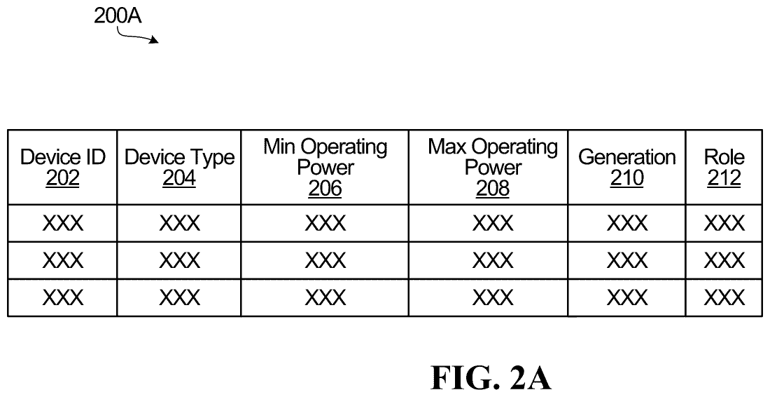

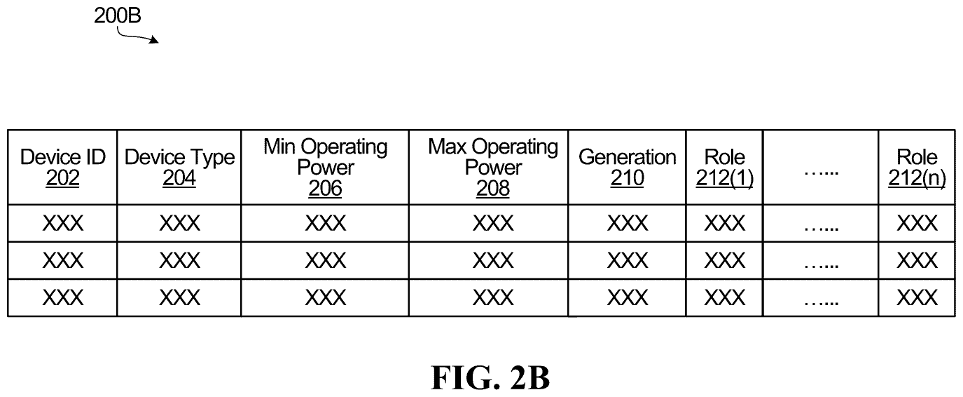

As shown in FIGS. 1A and 1B, the G2 device 102 provides power to a plurality of downstream devices 104(1)-104(8) over a plurality of hybrid data and power links 140(1)-140(8). As discussed above, the G2 device 102 may be the G2 PSE 108 (as presented in FIG. 1A) which supplies its own power or the G2 PCE 112 (as presented in FIG. 1B) which requires power and acquires it from the legacy PSE 110 to which it is connected via a hybrid data and power link 140(10). The G2 device 102 may maintain or access information pertaining to downstream devices and have the ability to implement a role-based power allocation policy to make power allocation decisions. Such information may be stored in the form of a table 200A (as also shown in FIG. 2A), which can be co-located with the G2 device 102 (stored on a non-transitory computer-readable medium) or accessible via an external network, such as a data network (e.g., the Internet, not shown). In other alternative examples, the table 200A may be stored in a remote server (e.g., a first server 130), and the G2 device 102 may look up an IP address of the first server 130 and access the table 200A in the remote server 130.

In the non-limiting example of FIGS. 1A and 1B, the downstream devices 104(1)-104(8) are all PCEs, consisting of a plurality of G1 PCEs 104(1)-104(5) and a plurality of legacy PCEs 104(6)-104(8). Although the plurality of G1 PCEs 104(1)-104(5) share the commonality that they are all G1 PCEs, the configuration (e.g., port type, number of ports of each port type, connection for each port, etc.,) of each G1 PCE may be different. For example:
(a) G1 PCEs 104(1) and 104(5) may each include at least one downstream port for connection to a single downstream device so as to only pass power downstream;
(b) G1 PCEs 104(2) and 104(3) may, in addition to including at least one downstream port to be connected to a downstream device to pass power downstream, also each further include at least one dedicated device port through which the G1 PCE 104(2), 104(3) taps power for a respective dependent powered device 106(1), 106(2). Non-limiting examples of a dependent powered device (such as the dependent power devices 106(1) and 106(2)) include an illumination device (as depicted in FIGS. 1A and 1B), camera, a gateway/router, a wireless access point, a smoke detector, a speaker, and so on; and
(c) G1 PCE 104(4) is an intermediate device that includes at least two downstream ports for passing received power further downstream.

In the example of FIGS. 1A and 1B, the plurality of legacy PCEs 104(6)-104(8) may be illumination devices (such as lights). In other examples, the plurality of legacy PCEs 104(6)-104(8) may be cameras, sensors, speakers, alarms, or a mix of these or other legacy devices.

It should be understood that the terms “downstream” and “upstream” discussed herein are relative terms. For example, the G1 PCEs 104(1)-104(5) and the legacy PCEs 104(6)-104(8) of the DPN 100 receive power from the G2 device 102 and thus can be considered as “downstream” devices relative to the G2 device 102. Analogously, the G2 device 102 is considered as an “upstream” device relative to the PCEs 104(1)-104(8).

The table 200A that is maintained by the G2 device 102 or accessed by the G2 device 102 via an external network, such as the internet, will be now described with reference to FIG. 2A. Each of the PCEs 104(1)-104(8) in the DPN 100 may be associated with various information that may be stored in the table 200A. The information in the table 200A for each PCE may be stored in the following data elements: a device identifier (ID) data element 202, a device type data element 204, a minimum operating power data element 206, a maximum operating power data element 208, a generation data element 210 and a role data element 212. These data elements are now described in further detail, for a given PCE:
(a) the device identifier (ID) data element 202 stores a device ID that uniquely identifies the given PCE in the DPN 100. Non-limiting examples of a device ID can include a MAC address, an IP address and/or a serial number, to name a few non-limiting possibilities;
(b) the generation data element 210 stores information that is indicative of whether the given PCE is a legacy device, G1 device, or G2 device. Naturally, different implementations may have fewer or more generations of devices and they may be named differently and have different functionalities than those described herein;
(c) the device type data element 204 stores a device type of the given PCE, which refers to a main or overarching behavioral characteristic of the given PCE, from an objective and general point of view. A predetermined behavior or a fixed behavior of the given PCE determines the device type of the given PCE. The device type of the given PCE is an inherent characteristic of the given PCE, which is irrelevant to configurations (e.g., network topology, generation of a PS, etc.) of the DPN 100. As such, the device type of the given PCE can be viewed as being independent of the DPN 100 in which the given PCE is connected. Non-limiting examples of a device type can include: illumination device, camera, smoke detector, router, speaker, wireless access point, printer, doorbells, video conferencing equipment (e.g., Voice over Internet Protocol (VoIP) phone, etc.), motorized blinds and shades, wall clocks, building management devices (e.g., sensors, controllers, meters, etc.), access control components (e.g., keyless entry, etc.), remote Point Of Sale (POS) kiosks, etc;
(d) the minimum operating power data element 206 stores information indicative of a minimum power needed to enable the given PCE to operate, and the maximum operating power data element 208 stores information indicative of a maximum power needed to enable the given PCE to operate. For example, for an illumination device that includes an LED lightbulb, the minimum operating power to run the lightbulb may be 0.5 watts (W) while the maximum operating power to run the lightbulb may be 1.0 W. In some examples, the minimum operating power may be equal to the maximum operating power. For instance, for a wireless access point, the minimum and maximum operating power (stored, respectively, in the minimum operating power data element 206 and the maximum operating power data element 208) may be 1.2 W, as 1.2 W is both a necessary and sufficient amount of power needed to power the wireless access point. In some examples, the minimum and maximum operating power may be pre-configured or pre-input by the administrator of the DPN 100. In other examples, each PCE may send its information to the G2 device 102 over the hybrid data and power links, and the G2 device 102 then records, maintains, or updates the entries in the table 200A; and
(e) the role data element 212 stores a “role” of the given PCE, which refers to a function within the DPN 100 that has been selectively associated with the given PCE. This function can be one that is carried out by the PCE, from the point of view of an administrator of the DPN 100 of the POE system. That is, the “role” defines a specifically assigned function which the PCE acts as in a particular DPN. As such, the role (stored in the role data element 212) differs from the device type (stored in the device type data element 204). For example, in some possible configurations, the role associated with the given PCE may be partly informed by the device type of the PCE, whereas in other possible configurations, the role associated with the given PCE is independent of the device type of the given PCE.

Roles can be selectively associated with the given PCE upon connection of the given PCE to the DPN 100 or at any subsequent time, or even ahead of time. The role associated with the given PCE, and therefore the information stored in the role data element 212, may require configuration input from the administrator of the DPN 100.

As roles may be defined from the point of view of a network administrator, many different roles may exist, and each scenario or DPN 100 may have its own unique set of roles. In a non-limiting example scenario, the roles specific to the DPN 100 may include: “safety”, “network connectivity”, “access control”, “routine”, “building management control”, “disease screen”, “air quality control”, and “unknown”. Of course, there may be any number of roles, and the roles may be different from those listed above.

It is noted that different devices having the same device type may have a different respective role within the DPN 100, which provides greater flexibility in power allocation. In particular, when there is (or is expected to be) not enough power available to power all PCEs in a network topology, such as the DPN 100, a role-based power allocation policy can be implemented to establish a set of principles or rules that codify how to make power allocation decisions.

Stated differently, the notion of “roles” allows multiple different devices of the same device type to be viewed as performing different functions in the DPN 100 and therefore to be prioritized differently. For instance, consider that a first downstream device is of a first device type and is associated with a first role. Consider also that another downstream device in the DPN 100 (referred to as a second downstream device) is of a second device type is associated with a second role. Here, the first device type and the second device type are identical whereas the first role may be different from the second role.

To take a practical example, in the case of numerous PCEs having the device type “illumination device”, some of these devices (e.g., every second light in the hallway and one light in each room) can be assigned the role “safety”, while the rest can be assigned the role “routine”. If the role-based power allocation policy places the “safety” role ahead of the “routine” role in terms of priority level, then this will enable at least partial illumination of the hallway and the rooms even when there is insufficient power to run all the lights, thereby demonstrating the advantage of turning lights on or off based on their role rather than merely on the fact that they are lights.

Accordingly, the present disclosure provides a method of allocating power to downstream devices with a role-based power allocation policy, which enables certain roles to be prioritized over other roles from a power allocation perspective. Thus, flexibility for power allocation and distribution in the DPN 100 may be improved significantly. In particular, in the DPN 100, the G2 device 102 of the POE system could implement the role-based power allocation policy to allocate power to the plurality of PCEs 104(1)-104(8) in an intelligent manner, particularly when the total power available to be provided by the G2 device 102 is insufficient for all the PCEs 104(1)-104(8).

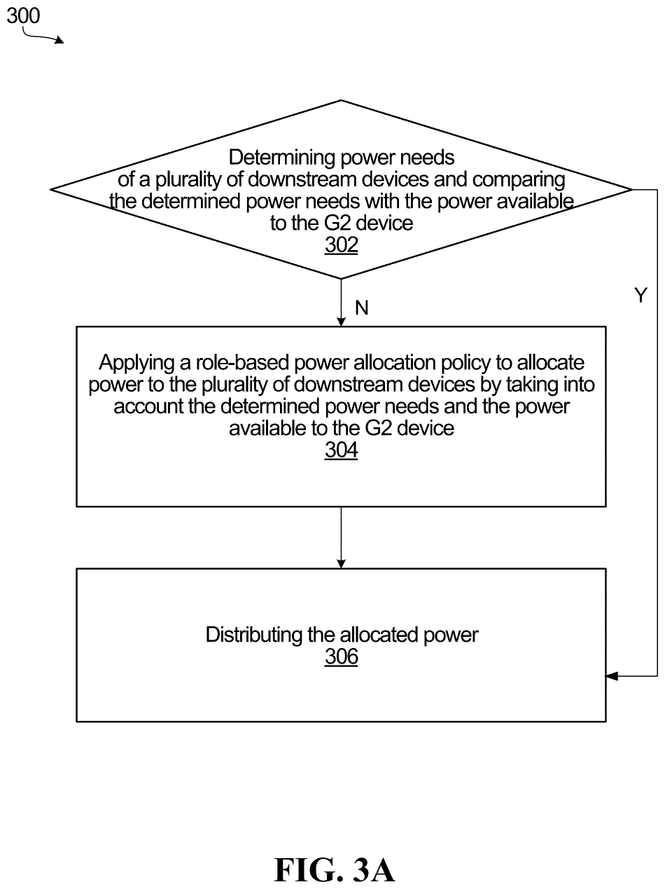

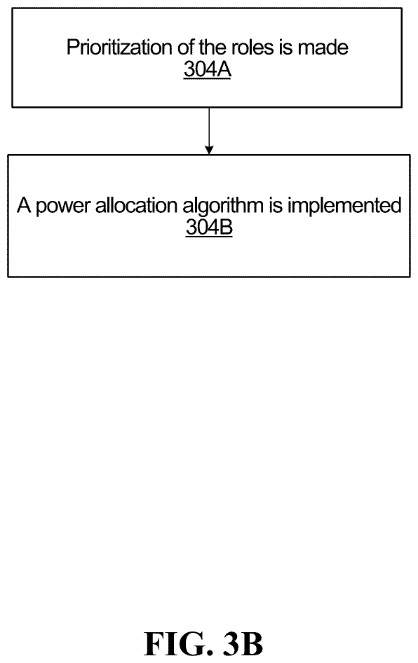

With this in mind, FIG. 3A illustrates a flowchart of a method 300 of allocating and distributing power in a DPN, such as the DPN 100, in accordance with an example embodiment. The method 300 may be implemented by the G2 device 102 within the DPN 100, more particularly by a processor of the G2 PSE 108 (FIG. 1A) or the G2 PCE 112 (FIG. 1B). A non-limiting embodiment of the method 300 can be described as follows:

At step 302, power needs of the plurality of downstream devices are determined and compared to the power available to the G2 device 102. The downstream devices may be all the PCEs 104(1)-104(8) downstream from the G2 device 102.

In some examples, the power needs of the plurality of downstream devices could be determined by collecting information (e.g., power requests) from the PCEs 104(1)-104(8) such that the power needs could be determined dynamically. That is, the G2 device 102 may receive a power request from one or more of the PCEs 104(1)-104(8), and the power needs of the plurality of downstream PCEs 104(1)-104(8) are determined based on such power requests received from various ones of the PCEs 104(1)-104(8). In other examples, each device type is associated with fixed power needs, and therefore the power needs of the plurality of downstream devices could be determined based on the device type of each of the PCEs 104(1)-104(8), as determined from the table 200A. In that case, the G2 device 102 may access the table 200A internally or externally to determine power need of each of the PCEs 104(1)-104(8) in the DPN 100 based on a device type of that PCE.

As for the power that is available to the G2 device, various approaches are possible. In case the G2 device is the G2 PSE 108 in FIG. 1A, the G2 PSE 108 may include a voltameter or an ammeter to detect how much current is passed over a certain time interval. The available amount of power can be calculated by using an amount of power that the G2 device can provide in total minus an output of integrating the detected passed current over the certain time interval. In case the G2 device is the G2 PCE 112 in FIG. 1B, the G2 PCE 112 may communicate with the legacy PSE 110 via the hybrid data and power link 140(10) to consult the legacy PSE 110 so as to determine how much power that the legacy PSE 110 can provide. The legacy PSE 110 may calculate an amount of power which it can provide in total and an integral of current over a certain time interval to determine an amount of power it can provide, and then send a message to G2 PCE 112 to indicate how much power is available to the legacy PSE 110.

If step 302 determines that the power available to the G2 device 102 is insufficient to meet the power needs of all the downstream PCEs 104(1)-104(8), then the G2 device 102 proceeds to step 304, where a role-based power allocation policy is applied to allocate power to the plurality of downstream devices by taking into account the determined power needs of the downstream devices. For instance, the G2 device will determine which of the PCEs will be allocated the power that they need and which of the PCEs will be allocated less power than they need or no power at all. The decision is reached by running a power allocation algorithm that is consistent with a collection of rules that defines a prioritization of certain roles over certain other roles; this is the role-based power allocation policy and will be described in further detail later on. In some examples, the role-based power allocation policy can be pre-set by a network administrator with a bias that reflects the relative importance given by the network administrator to different roles under different circumstances.

At step 306, the allocated power (resulting from application of the role-based power allocation policy to the configuration/topology of the DPN 100) is distributed to each of the downstream devices, namely the PCEs 104(1)-104(8). Specifically, once the role-based power allocation policy has been applied and the power to be allocated to the plurality of downstream devices has been determined (see step 304), the G2 device 102 then distributes the allocated power to the PCEs 104(1)-104(8) via the hybrid power and data links in the DPN 100.

Power can be distributed together with instructions destined for each G1 PCE (in this case, PCEs 104(1)-104(5)). Thus, the G1 PCE receives the instructions and accordingly distributes the received power to further downstream G1 PCEs, further downstream legacy PCEs and dependent devices. In some applications, some of the received power may be utilized to carry out a local function of the G1 PCE (if applicable).

In contrast to a G1 PCE, a legacy PCE receives the power that it has requested and carries out its local function, without further downstream distribution of the received power.

It is noted that the term “local function” means a basic functionality of a device. For example, although a G1 PCE may have the ability to pass power to downstream device and distribute power to dependent devices, the G1 PCE may also be configured with a basic functionality, such as lighting, providing wireless access, or acting as a speaker, camera or printer.

Referring back to step 302, if it is determined that the power available to the G2 device 102 is indeed sufficient to meet the power needs of all the downstream PCEs 104(1)-104(8), then there is no need for a role-based power allocation policy to be applied at step 304, and the G2 device 102 proceeds directly to step 306, where the required amount of power to each of the downstream PCEs 104(1)-104(8) is distributed.

### Role-Based Power Allocation Policy

Non-limiting examples of applying the role-based power allocation policy (as discussed in step 304 of FIG. 3A) will now be described in further detail. The role-based power allocation policy may be stored as a data structure 150 in the memory of the G2 device 102 in the example of FIG. 1A or in an external server, such as a second server 160 as shown in FIG. 1A. In some embodiments, the role-based power allocation policy can be viewed as (i) a collection of rules for prioritizing the roles and (ii) a power allocation algorithm.

Accordingly, and with reference now to the flowchart in FIG. 3B, applying the role-based power allocation policy can be broken down into (i) prioritization of the roles (step 304A) according to the rules for prioritizing the roles; and (ii) execution of the power allocation algorithm (step 304B).

In one embodiment of step 304A, the rules for prioritizing the rules could include a hard-coded list of roles in (e.g., decreasing) order of priority level. This hard-coded order of priority levels for the various roles can be provided by the administrator, or can be stored as a default priority level order in the memory of the G2 device 102. For example, in the case of the eight roles mentioned above (i.e., “safety”, “network connectivity”, “access control”, “routine”, “building management control”, “disease screen”, “air quality control”, and “unknown”), the collection of rules for prioritizing the roles could be defined as the following list of roles in decreasing order of priority level: “safety”, “access control”, “network connectivity”, “building management control”, “disease screen”, “air quality control”, “routine” and “unknown”.

In another embodiment of step 304A, rather than specify a hard-coded order of the priority levels for the various roles, the rules for prioritizing the roles could include constraints on the relative priority levels of the various roles. For example, in the case of the eight roles mentioned above (i.e., “safety”, “network connectivity”, “access control”, “routine”, “building management control”, “disease screen”, “air quality control”, and “unknown”), the rules for prioritizing the roles could include the following constraints:
The “safety” role has at least the third highest priority level;
The “network connectivity” role has no less than the second highest priority level;
The “access control” role has the highest priority level;
The “routine” role has no more than the second lowest priority level;
The “building management control” role has at least the fourth highest priority level;
The “disease screen” role has no more than the fourth lowest priority level;
The “air quality control” role has no more than the third lowest priority level; and
The “unknown” role has the lowest priority.

Given the above constraints on the relative priority levels of the various roles, the processor of the G2 device 102 is configured to place the roles in order of priority level so that the constraints are respected. This could lead to the following list of roles, in decreasing order of priority level: “access control”, “network connectivity”, “safety”, “building management control”, “disease screen”, air quality control”, “routine” and “unknown”.

In yet another embodiment of step 304A, the rules for prioritizing the roles may include consideration of “contextual factors”. Contextual factors represent potentially dynamic information that can be obtained from various sensors, computers, or other sources, including from POE devices, whether inside or outside the DPN 100. In some examples, contextual factors can include temporal factors such as date, day of the week, time of the day, etc. Contextual factors can also include sensed data/conditions, such as light intensity, sunlight level, threat level, indoor or outdoor temperature, movement (including specific movements), sound (including specific sounds), smoke detector output, room/building occupancy, power grid status, etc. It is worth noting that the prioritization of certain roles over certain other roles may be different for different sets of prevailing contextual factors.

As such, application of the rules for prioritizing the roles could result in a particular role having a different priority level depending on one of the aforesaid contextual factors. For instance, a contextual factor may be building occupancy. If the building occupancy is high (e.g., above a threshold number of people), the “network connectivity” role can be assigned a certain higher priority level (as it is important to provide connectivity for the people in the building) and if the building occupancy is not high, the “network connectivity” role can be assigned a lower priority level.

Having prioritized the various roles (i.e., step 304A), which in some cases may be exemplified by having created of an ordered list of roles according to priority level, a power allocation algorithm (i.e., step 304B) is then executed by the processor of the G2 device 102 in order to allocate power to downstream devices (e.g., PCEs 104(1)-104(8)) in a DPN (e.g., DPN 100).

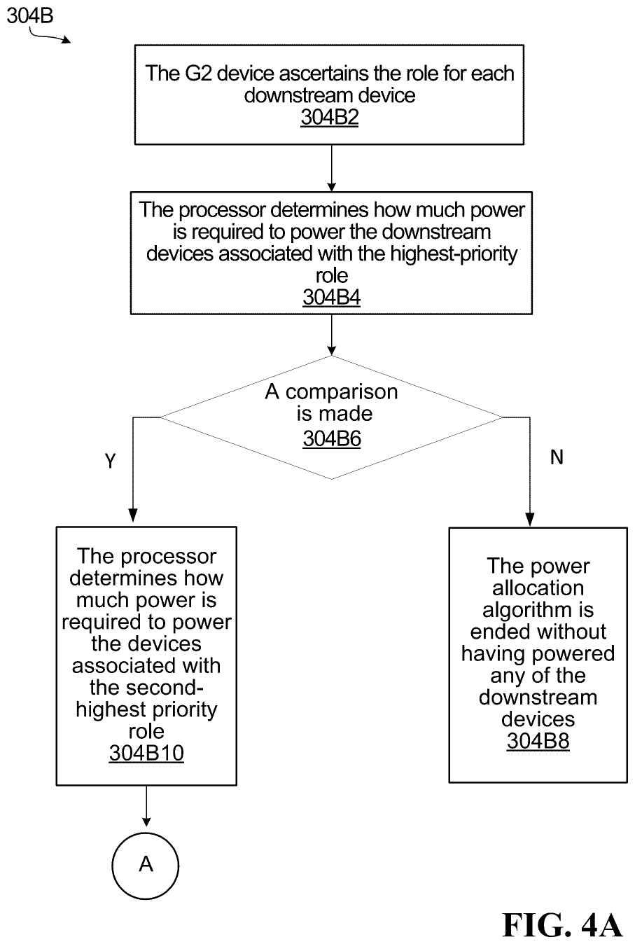

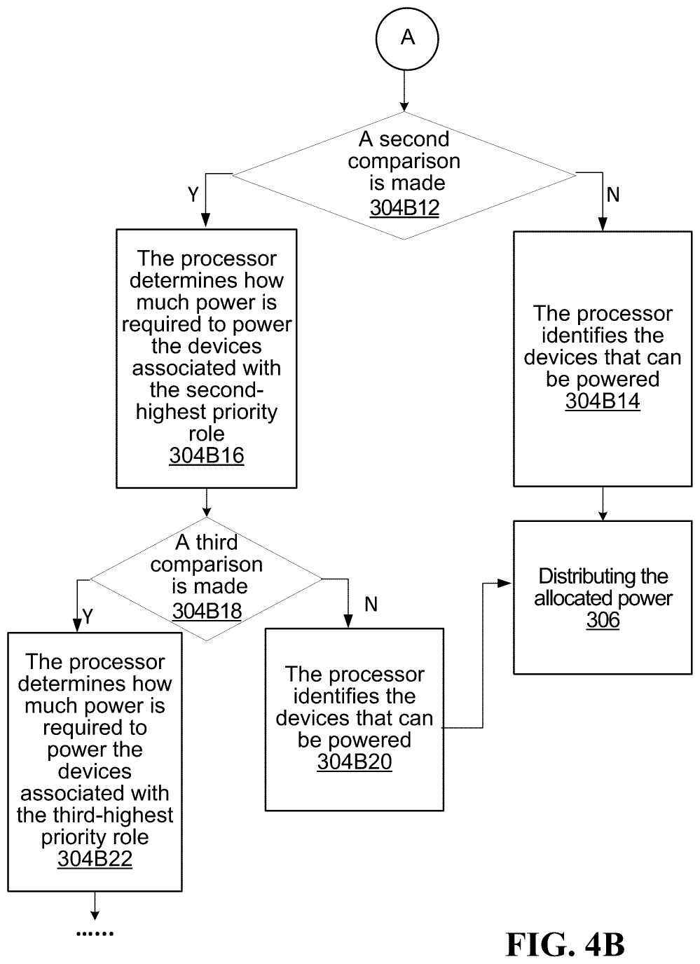

Accordingly, reference is now made to a flowchart in FIGS. 4A-4B, which expands step 304B from FIG. 3B, namely the power allocation algorithm. It should be noted that FIGS. 4A-4B illustrate a single flowchart where a reference letter A labeled in a circle connects step 304B10 in FIG. 4A with step 304B12 in FIG. 4B. The reference letter A is only presented in FIGS. 4A-4B for the purpose of easing understanding and is not intended to be limiting. Various steps of the power allocation algorithm are thus now described:

At step 304B2, the G2 device may ascertain the role for each downstream device.

In some applications, for a given downstream device, the G2 device may obtain or extract a device ID of the downstream device and then consult the table 200A in FIG. 2A to look up the role for the downstream device, e.g., by looking up the information in the role data element 212 of table 200A.

In other applications, a single device may be associated with multiple roles (e.g., as indicated in role data elements 212(1)-212(n) in the table 200B of FIG. 2B). In such a case, the G2 device 102 may determine a contextual factor associated with the device and determine which of the multiple roles should be associated with the device at the present time. That is to say, a role of the device may be selected from a plurality of potential roles (e.g., the multiple roles) based on the contextual factor.

To take a specific example, consider a certain illumination device associated with both a “safety” role and a “routine” role. The current role associated with the certain illumination device may change dynamically between “safety” and “routine” based on a contextual factor which with the device is associated. In this specific example, this contextual factor could be the time of day, such that if the current time is between 7 AM and 5 PM, the role associated with the given downstream device (e.g., a ceiling light in a hallway) is “routine”, whereas outside this period, the role associated with the ceiling light is “safety”. This may not be the case with other ceiling lights, such as a ceiling light in an office, which could always be associated with the “routine” role.

Having ascertained the current role for each downstream device (step 304B2 in FIG. 4A) and having prioritized the various roles (step 304A in FIG. 3B), the G2 device knows which downstream devices in the DPN 100 are at each priority level, at any given time. It is noted that such prioritization of individual devices stems from having attributed a role to each device and from prioritizing the roles based on input from an administrator who may have specific objectives as to how the DPN 100 should be managed. This can result in seemingly identical devices (from the point of view of device type) being prioritized differently in order to achieve such objectives.

At step 304B4, the G2 device may now decide to allocate power to downstream devices associated with a highest-priority role amongst ascertained roles of the plurality of downstream devices first. To this end, the G2 device looks up the table 200A and obtains a minimum operating power 206 corresponding to the downstream device(s) with the highest-priority role. Such minimum operation power 206 is considered as the power required to power such downstream device(s). In alternative implementations, the maximum operating power 208 may be utilized as the power required to power such downstream device(s).

At step 304B6, a comparison is made. In particular, the comparison is made to determine if there is sufficient power to power the downstream device(s) associated with the highest-priority role. If the comparison reveals that there is insufficient power to power the downstream device(s) associated with the highest-priority role, then the processor proceeds to step 304B8, where the power allocation algorithm ends without having powered any of the downstream devices.

However, if the comparison of step 304B6 reveals that there is sufficient power to power the downstream device(s) associated with the highest-priority role, then the processor proceeds to step 304B10, where the processor determines how much power is required to power the downstream device(s) associated with the second-highest priority role.

At step 304B12, a second comparison is made.

If the second comparison reveals that there is insufficient power to power the downstream device(s) associated with the second-highest priority role, then the processor proceeds to step 304B14, where the processor identifies the downstream device(s) that can be powered (in this case, the devices associated with the highest-priority role, which can be identified from the table 200A) and proceeds to step 306 (previously discussed with reference to FIG. 3A) whereby the appropriate amount of power is caused to be distributed via the hybrid data/power links 140(1)-140(8).

If, on the other hand, the second comparison at step 304B12 reveals that there is sufficient power to power the downstream device(s) associated with the second-highest priority role, then the processor proceeds to step 304B16, where the processor determines how much power is required to power the downstream device(s) associated with the third-highest priority role. At step 304B18, a third comparison is made.

If the third comparison reveals that there is insufficient power to power the downstream device(s) with the third-highest priority role, then the processor proceeds to step 304B20 similar to aforementioned step 304B14, where the processor identifies the downstream device(s) that can be powered (in this case, the devices associated with the highest-priority role and the devices with the second-highest-priority role, as identified from the table 200A) and proceeds to step 306 (previously discussed with reference to FIG. 3A) whereby the appropriate amount of power is caused to be distributed via the hybrid data/power links 140(1)-140(8).

If, on the other hand, the third comparison at step 304B18 reveals that there is sufficient power to power the downstream device(s) associated with the third-highest priority role, then the processor proceeds to step 304B22, where the processor determines how much power is required to power the downstream device(s) associated with the third-highest priority role.

The above algorithm structure can be repeated for all priority levels.

In the aforementioned example of the ceiling lights, by prioritizing “safety” above “routine”, and by continually running the role prioritization by taking into consideration the contextual factor (in this case, time of day), a ceiling light in the hallway can be lit even when there is not enough power to run all the ceiling lights (whereby the ceiling lights in the office would remain dark), yet when there is enough power to run all routine downstream devices, all ceiling lights would be lit, including those in the hallway and those in the office.

Those skilled in the art will appreciate that when applying the role-based power allocation policy, care should be taken to ensure that a maximum power rating for the hybrid data/power links in the DPN is not exceeded.

Those skilled in the art will also appreciate that the above power allocation algorithm is merely one example, and that there many variants are possible. Additionally, in some embodiments, the role-based power allocation policy may specify additional power allocation constraints on the prioritized roles. Examples of such constraints could be:
when the power budget is insufficient to meet all demand, fully de-allocate all power to the lowest-priority devices;
devices associated with the “unknown” role must not be allocated more than a pre-set value (e.g., 0.5 watts);
etc.

Those skilled in the art will also appreciate that multiple sub-policies can be created for different sets of circumstances. For example, consider a first sub-policy (which includes a first collection of rules for prioritizing the roles and a first power allocation algorithm) and a second sub-policy rules (which includes a second collection of rules for prioritizing the roles and a second power allocation algorithm). A “metarule” may govern which sub-policy applies, based on one or more contextual factors.

For example, consider that the contextual factor is the time of day, with the first sub-policy being suitable for daytime and the second sub-policy being suitable for nighttime. In other words, the metarule may dictate that the daytime collection of power allocation rules applies between sunrise and sunset (as detected by an external sensor or from online data), and that the nighttime collection of rules applies between sunset and sunrise. Hence, there may be a collection of rules for the daytime, a collection of rules for the nighttime and a metarule governing when each applies. In another example, the first sub-policy may be suitable for weekdays and the second sub-policy may be suitable for weekends, and so on. Naturally, there may be any number of sub-policies and any number of contextual factors to influence the choice of sub-policy.

Those skilled in the art will appreciate that one or more contextual factors may therefore have an impact in determining one or more of: (i) prioritization of roles (in the case of step 304A); (ii) which role is associated with a given device (in the case of step 304B2); and (iii) which sub-policy is applicable (in the case where there are multiple sub-policies together forming the role-based power allocation policy).

### Alternative Method

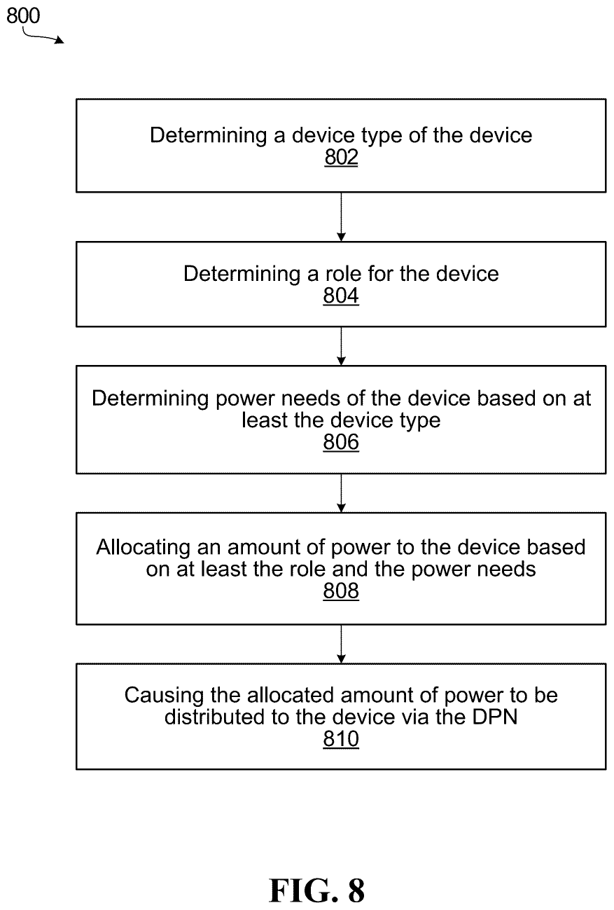

As discussed in the aforementioned step 302, the power needs for each of the plurality of downstream devices may be determined dynamically, such as based on power requests sent from each of the plurality of downstream devices or based on each device type. In a scenario where the device type is utilized to determine power needs of each downstream device, an alternative method may be implemented to allocate power for a device of the plurality of downstream devices. With reference to FIG. 8, various steps of the method 800 are now described.

At step 802, a device type of the device is determined. The device type corresponds to a fixed behavior of the device independent of the DPN. The determined device type of the device is then employed to determine power needs of the device at step 806.

At step 804, a role for the device is determined. The role corresponds to a function within the DPN that has been selectively associated with the device. This step may be similar to the aforementioned step 304B2.

At step 808, an amount of power is allocated to the device based on at least the role and the power needs. Based on the determined role and the determined power needs, an upstream device (e.g., G2 device 102) may apply a role-based power allocation policy to allocate an amount of power to the device. Implementation of the role-based power application policy at step 808 may be similar to part of detailed steps of implementing the role-based power application policy at the aforementioned step 304. For example, a role of the device is determined to be a second-highest priority role. In that case, step 808 will be implemented similarly to step 304A of prioritizing roles and steps 304B4-304B16 to determine the amount of power to the device with a specific role (e.g., the second highest priority role).

At step 810, the allocated amount of power is caused to be distributed to the device via the DPN. Such step is similar to the step 306 as discussed above.

The method 800 utilizes an inherent characteristic (e.g., device type) of a device to determine power needs of the device, which may help to improve efficiency of power allocation, in contrast with other possible approaches to determine the power needs of the device.

### Power Domain

The notion of a “power domain” is now described. It will be appreciated that a given PSE may correspond to a power domain consisting of various PCEs to which that PSE supplies power. In the illustrated network topology of the DPN 100, there is a single power domain because only a single source (namely, G2 PSE 108 of FIG. 1A or legacy PSE 110 of FIG. 1B) exists to provide power to the various PCEs in the DPN 100. However, there may be two or more power domains in a DPN. In such a case, prior to allocating power to a specific downstream device by implementing the role-based power allocation policy, the G2 device 102 may determine if the specific downstream device resides in a power domain that is different than a power domain provided by the G2 device 102.

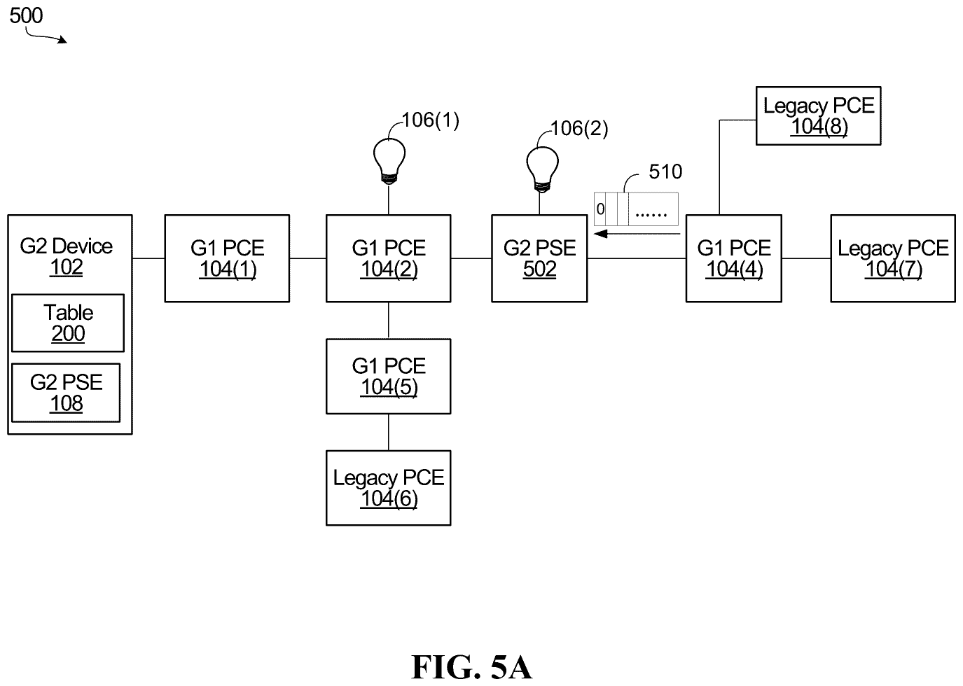

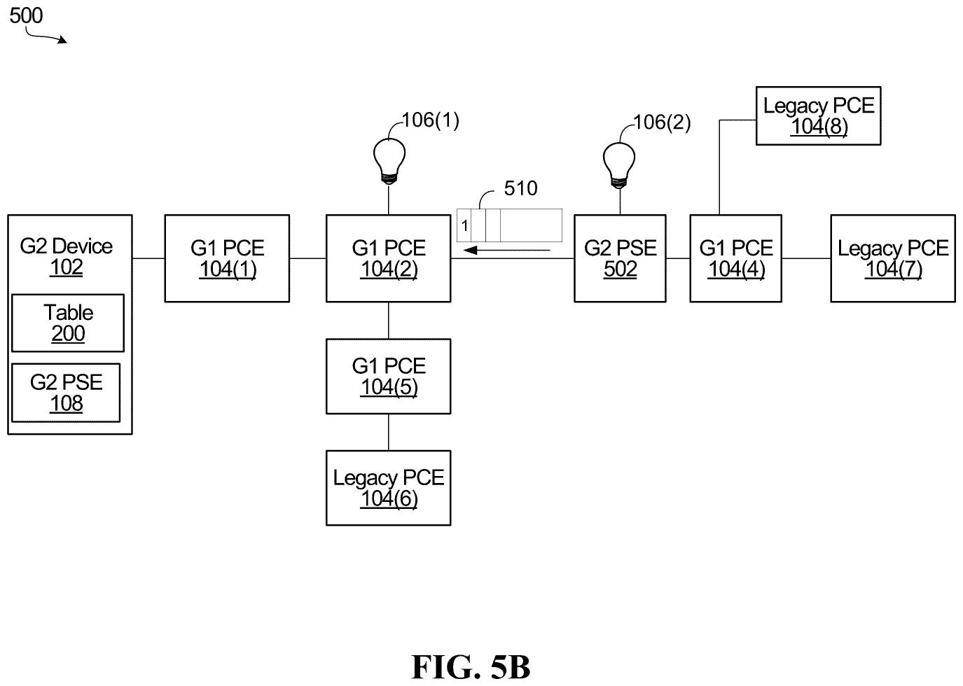

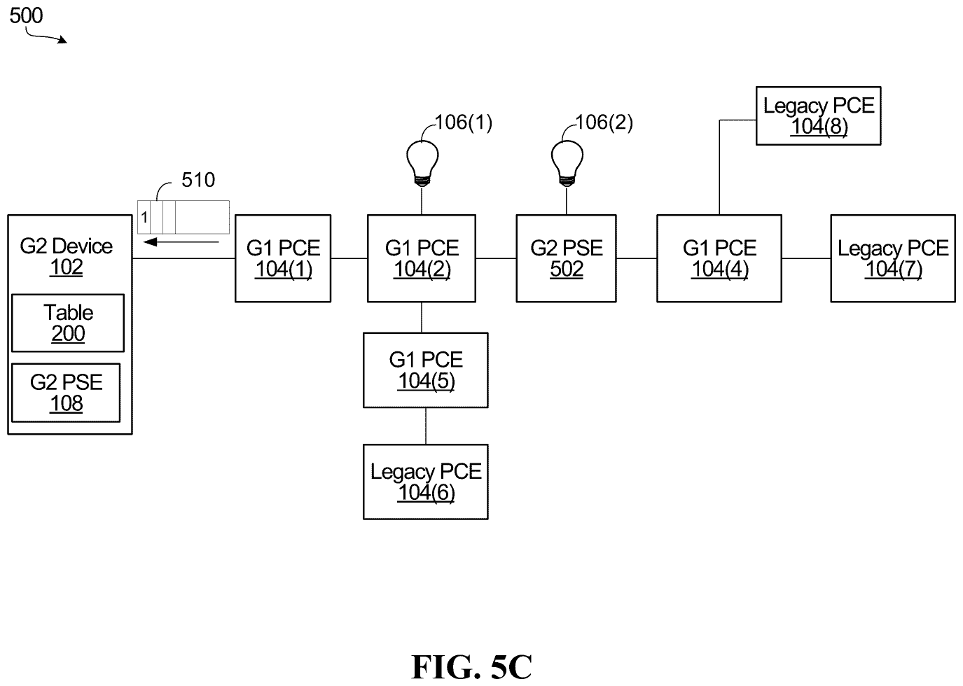

FIGS. 5A-5C present an alternative example DPN 500 including two different power domains in accordance with alternative example embodiments. A network topology of the DPN 500 as shown in FIGS. 5A-5C is similar to that of the DPN 100 as shown in FIG. 1 except that the G1 PCE 104(3) of FIG. 1A is replaced with a G2 PSE 502 having the ability of power sourcing and providing its own power domain. A different respective power domain corresponds to a different PSE and therefore since DPN 500 in FIGS. 5A-5C includes two different PSEs, it includes two different power domains. Specifically, G2 Device 102 provides a first power domain and G2 PSE 502 provides a second power domain. It is noted that although the G2 device 102 in FIGS. 5A-5C includes a G2 PSE 108 to provide a second power domain, the G2 device 102 in FIGS. 5A-5C could also be a G2 PCE that sends power requests and receives power from a legacy PSE (e.g., as per the configuration of the G2 PCE 112 and the legacy PSE 110 shown in FIG. 1B).

As shown in FIGS. 5A-5C, there exist two G2 PSEs in the DPN 500, namely a first G2 PSE 108 providing the first power domain and a second G2 PSE 502 providing the second power domain. In some examples, the first G2 PSE 108 and the second G2 PSE 502 may implement separate role-based power allocation policies because the first G2 PSE 108 and the second G2 PSE 502 manage respectively separate power domains. In such a scenario, prior to implementing the role-based power allocation policy to allocate power to a specific device, the first G2 PSE 108 may determine if the specific device belongs to second power domain (i.e., the one provided by the second G2 PSE 502). This can be done by configuring each PSE to set an indicator when a power request is received in the upstream direction from a downstream device that is within that PSE's power domain. In that case, when a power request from the specific device within the power domain of the G2 PSE 502 passes through the G2 PSE 502, the G2 PSE 502 will set an indicator within the power request to indicate that the specific device has been already associated with the power domain of the G2 PSE 502. Thus, when the G2 PSE 108 further upstream receives the power request from the specific device, the G2 PSE 108 can tell that the specific device resides in another power domain by determining if the power request includes the aforementioned indicator. Accordingly, the G2 PSE 108 would skip allocating power to the specific device. In some non-limiting applications, the indicator, or flag, may be setting “1” in one bit of a frame included in the power request.

With reference to FIG. 5A, taking a power request 510 sent from the G1 PCE 104(4) as an example, when the power request 510 originating from the G1 PCE 104(4) passes through the second G2 PSE 502, the second G2 PSE 502 will determine if the power request 510 includes an indicator indicating that the G1 PCE 104(4) is already included in a power domain, such as by checking if a bit of a frame included in the power request is “1”. For example, check a first bit of a frame of the power request 510 is “1”. If it is determined that the power request does not include the indicator, that means there is no power domain, in a downstream direction relative to the G1 PCE 104(4), in which the G1 PCE 104(4) resides. As shown in FIG. 5A, the second G2 PSE 502 determines that the first bit of the frame of the power request 510 is “0”. That means, there is no power domain in which the G1 PCE 104(4) resides in the downstream direction relative to the G1 PCE 104(4). Assuming this to be the case, when the power request passes through the second G2 PSE 502, the second G2 PSE 502 adds an indicator to the power request 510 to indicate that the G1 PCE 104(4) is included in the power domain managed by the second G2 PSE 502 (i.e., the second power domain) and then sends the power request 510 upstream. Reference is now made with respect to FIG. 5B, which shows that the power request 510 is changed by the second G2 PSE 502. As shown in FIG. 5B, the second G2 PSE 502 sets the first bit of the frame in the power request 510 to “1” to indicate that the G1 PCE 104(4) resides in the power domain managed by the second G2 PSE 502. FIG. 5C presents how the power request 510 indicates that the G1 PCE 104(4) resides in a power domain that is a downstream direction relative to the first G2 PSE 108. As demonstrated in FIG. 5C, when the power request 510 arrives at the first G2 PSE 108, the first G2 PSE 108 will determine if the power request 510 includes an indicator indicating that the G1 PCE 104(4) is in a power domain, such as by checking if a bit of a frame included in the request is “1”. With reference to FIGS. 5B and 5C, since the second G2 PSE 502 has already added “1” in the frame (e.g., in the first bit of the frame), the first G2 PSE 108 determines that the power request 510 includes an indicator that the G1 PCE 104(4) is already included in a power domain. Since the G1 PCE 104(4) is in a power domain managed by another other PSE (in this case, the second G2 PSE 502), that other PSE will be responsible for allocating power to the G1 PCE 104(4). Accordingly, the first G2 PSE 108 will skip allocating power to the G1 PCE 104(4).

### Alternative DPN Configuration

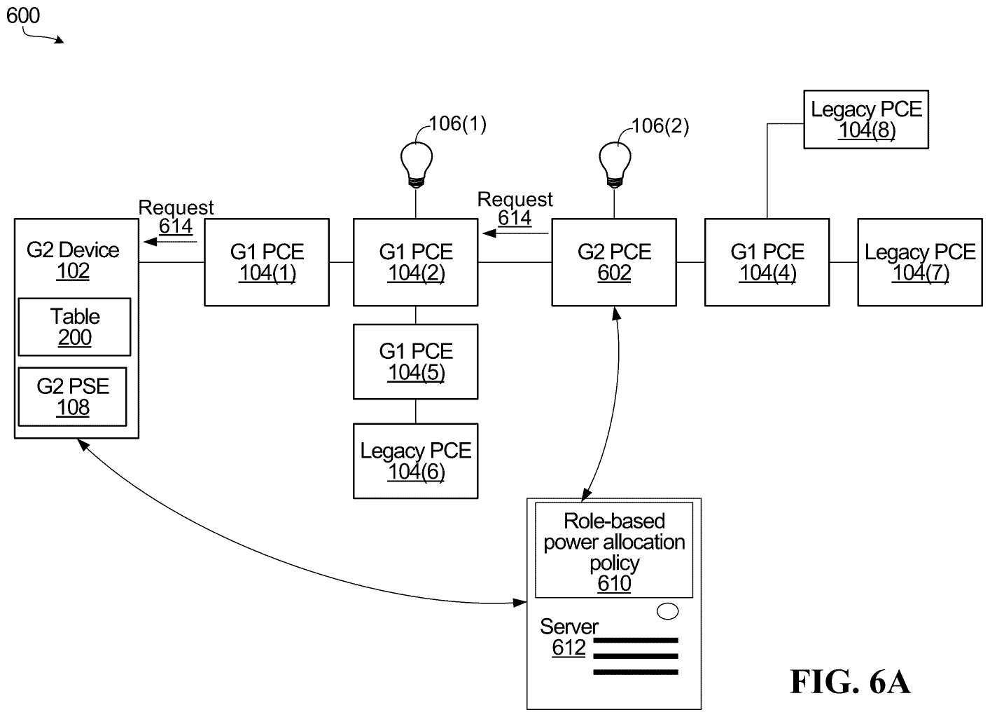

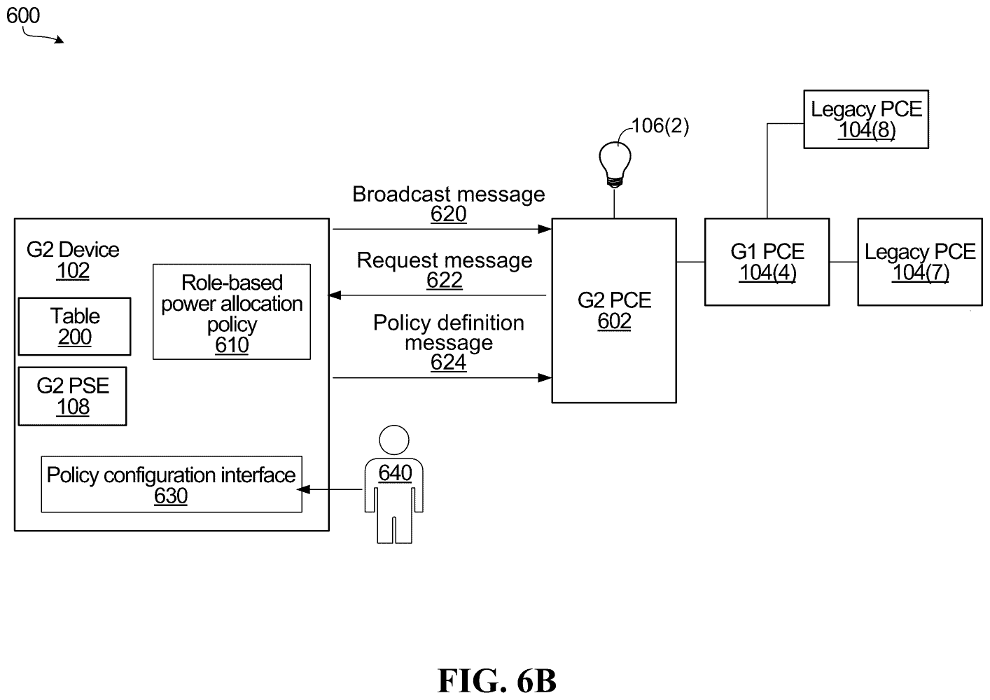

FIG. 6A is an alternative example DPN 600 including a G2 PCE 602 downstream relative to the G2 device 102. A network topology of the DPN 600 in FIG. 6A differs from that of the DPN 500 in FIGS. 5A-5C by replacing the second G2 PSE 502 in FIGS. 5A-5C (which can source power) with a G2 PCE 602 in FIG. 6A that does not have the ability to source power, although it retains the ability to distribute received power.

In a given DPN, each power domain corresponds to a respective role-based power allocation policy, and whether two G2 devices apply a same role-based power allocation policy depends on whether the two G2 devices are located in a same power domain. In the example of FIG. 6A, since there is one PSE in the DPN 600 (namely, the G2 PSE 108), there is a single role-based power allocation policy associated with the DPN 600, regardless of how many G2 devices in the DPN 600. That is, even though multiple G2 devices have the ability to implement role-based power allocation policies (by virtue of being G2 devices), as long as the devices are located within a common power domain, the role-based power allocation policies may be identical and could be commonly accessed. For example, the identical role-based power allocation policy may be stored in a server (not shown) that can be commonly accessed by those G2 devices in a same power domain. In other examples, a network administrator may pre-configure each G2 device manually to enable all the G2 devices in the same power domain to store a common role-based power allocation policy.

In the example of FIG. 6A, the G2 PCE 602 may have access to the same role-based power allocation policy as the G2 PSE 102, for example, by requesting accessing a role-based power allocation policy 610 that is remotely stored in a server 612. In an example implementation, the G2 device 102 may first determine if the device 602 has the ability to implement the role-based power allocation policy 610 by extracting generation information (e.g., the generation information forming part of the generation data element 210 in the table 200A shown in FIG. 2A) of the device 602. For example, when the G2 device 102 receives a power request 614 that is originated from the G2 PCE 602 and addressed to the G2 device 102, the G2 device 102 may extract the generation information from the power request 614. In other examples, the G2 device 102 may obtain the device ID 202 from the power request 614 and then look up entries of the table 200A to determine the generation information 210 of the device sending the power request 614. In addition, the G2 device 102 also determines that the device 602 is a PCE because the device 602 sends the power request 614 to the G2 device 102. Thus, the G2 device 102 can determine that the device 602 is a G2 PCE. That means, it is determined that the G2 PCE 602 has the ability to implement the role-based power allocation policy to allocate power to one or more devices in a downstream direction relative to the G2 PCE 602. In that case, the G2 device 102 would let other G2 devices implement the role-based power allocation policy to allocate power to devices in a downstream direction relative to such other G2 devices. In particular, the G2 device 102 would obtain respective minimum operating power for each device (e.g., G1 PCE 104(4), legacy PCE 104(7), and legacy PCE 104(8)) in the downstream direction of the G2 PCE 602 and minimum operating power for the G2 PCE 602 itself. The G2 device 102 will sum up the respective minimum operating power of the devices in the downstream direction of the G2 PCE 602 and minimum operating power for the G2 PCE 602, and then allocate total minimum operating power to the G2 PCE 602 to enable the G2 PCE 602 to implement the role-based power allocation policy to the devices in the downstream direction of the G2 PCE 602. In this scenario, G2 device 102 will let another G2 device (e.g., G2 PCE 602) to implement the role-based power allocation policy to allocate power for the devices in the downstream direction of the G2 device, rather than carrying out the allocation itself.

It is to be appreciated that although the G2 device 102 and the G2 PCE 602 remotely access an identical role-based power allocation policy that is stored in a server 612 as shown in FIG. 6A, this is for ease of illustration and is not intended to be limiting. In some alternative examples, a policy discovery protocol is implemented to distribute a role-based power allocation policy across multiple G2 devices in the DPN in order for the multiple G2 devices to be made aware of the role-based power allocation policy.

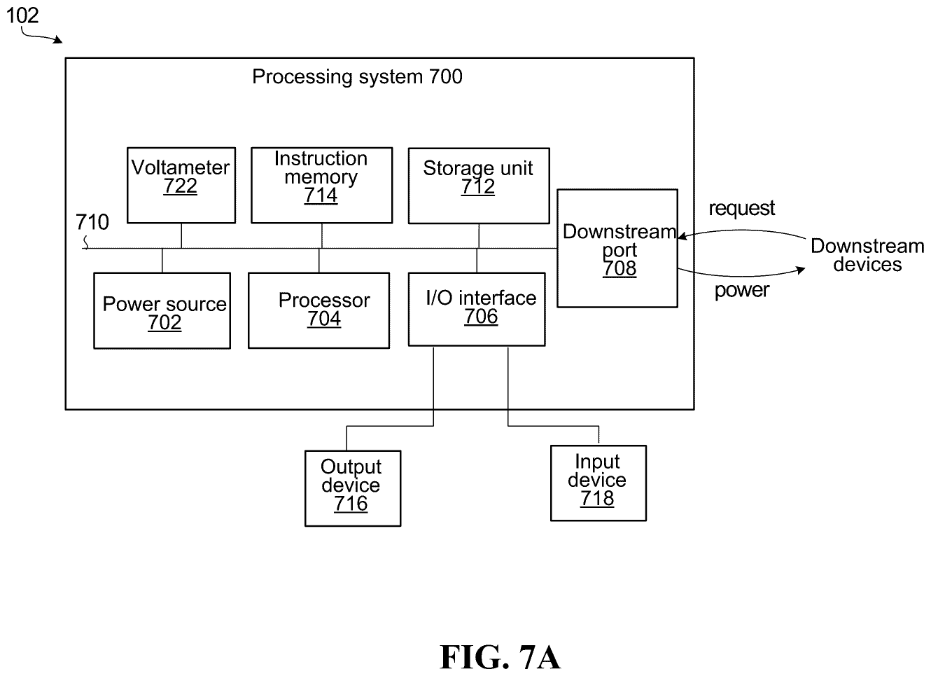

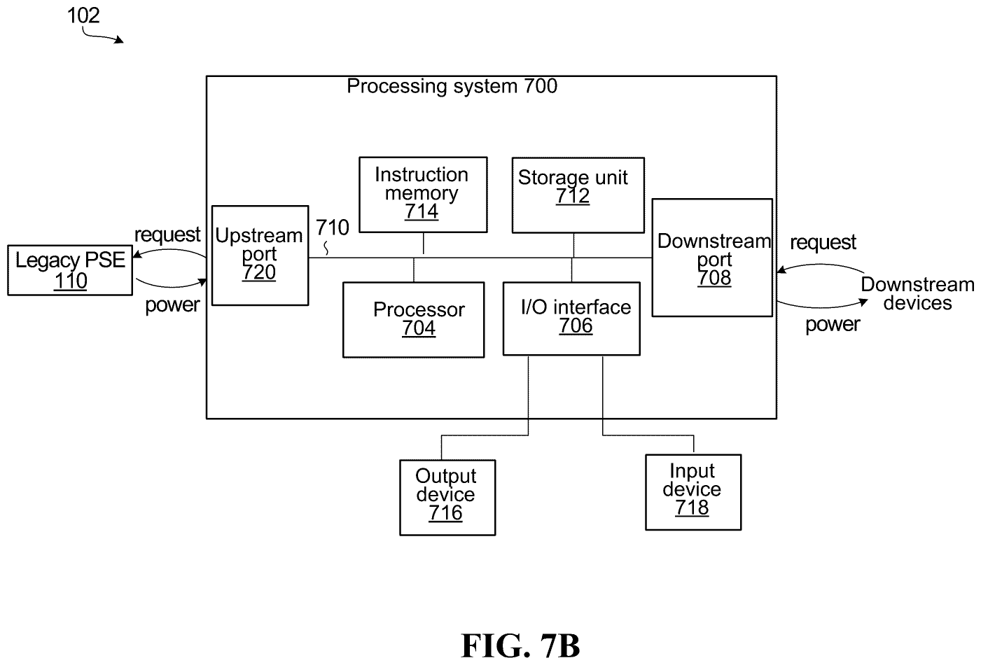

FIG. 6B shows a simplified network topology 600 where devices between the G2device 102 and the G2 PCE 602 are omitted for purpose of illustrating message exchanges between the G2 device 102 and the G2 PCE 602 to implement the policy discovery protocol. As shown in FIG. 6B, the G2 PSE 108 is a power source and has the ability to apply the role-based power allocation policy. G2 PSE 108 in this example may have a policy configuration interface 630, which may be an input device 718 as shown in FIGS. 7A and 7B, through which it has received a role-based power allocation policy 610 from a user (e.g., an administrator 640 of the DPN 600).

The policy discovery protocol may include signaling. Specifically, the G2 PSE 108 may send a broadcast or multicast message 620 (which can also be referred to as a “definition announcement message”) announcing that it has a role-based power allocation policy 610 to disseminate. In this manner the knowledge of the existence of a role-based power allocation policy is pushed (i.e., push messaging). Eligible G2 devices may then optionally decide whether to pull the role-based power allocation policy. The other G2 devices in the DPN, such as the G2 PCE 602, may thus send a request message 622 to the originator (e.g., G2 device 102) of the definition announcement message 620 defining itself as a G2 device and/or requesting the role-based power allocation policy 610, or access parameters therefor. This can be referred to as a “policy pull message” 622. In response, the G2 PSE 108 may send a “policy definition message” 624 back to the requestor (e.g., the other G2 devices or the G2 PCE 602) comprising either the some or all of the information in the role-based power allocation policy 610 itself (e.g., only the portions that apply to the requesting device, e.g., based on its role, only the portions that apply to the devices in the downstream direction of that requesting devices) or access parameters defining how to access the role-based power allocation policy 610. Alternatively, the entire role-based power allocation policy 610 may be broadcast or multicast through the policy definition message 624 throughout the network or part thereof (e.g., only to G2 devices if such devices are already known).

In some examples, other G2 devices may issue a “policy announcement pull message”, thereby polling the network for the role-based power allocation policy using the policy announcement pull message. This implementation may resemble a modified network topology discovery process. G2 devices may broadcast or multicast a request for knowledge about other G2 devices, and/or devices having capability to access the role-based power allocation policy 610.

As a result of implementing the above policy discovery protocol, all the G2 devices in the same power domain will have access to the same the role-based power allocation policy, in order to coordinate power allocation implemented by the G2 devices (and prevent power allocation mismatch scenarios).

### Configuration of G2 Device

FIGS. 7A and 7B are block diagrams showing components of two example simplified G2 devices 102, which may be used to apply the role-based power allocation policy to implement a method of power allocation, such as method 300 as shown in FIG. 3A and/or step 304 as shown in FIG. 3B.

FIG. 7A presents components of a processing system 700 of a G2 device 102 in the case where the G2 device 102 is a G2 PSE. The processing system 700 may include a power source 702 for distributing and sourcing power based on power allocation implemented by a processor 704. The processor 704 is incorporated in the G2 device 102 to implement the power allocation to devices within in the DPN 100, 500, 600. The processor 704 may apply a role-based power allocation policy to determine a role of each specific downstream device and make decisions as to how much power will be allocated to the specific downstream device. The process of applying the role-based power allocation policy may include method 300 and/or step 304 as depicted in FIGS. 3A-3B.

The processor 704 could be any type of processing unit, such as a central processing unit (CPU), a graphics processing unit (GPU), a tensor processing unit (TPU), a neural processing unit (NPU), an application-specific integrated circuit (ASIC), a field-programmable gate array (FPGA), a dedicated logic circuitry, or combinations thereof.

The processing system 700 may include an input/output (I/O) interface 706, to enable interfacing with downstream device externally, via a downstream port 708. The downstream port 708 is a bidirectional port and can be used an interconnection port for the processing system 700 to receive requests from downstream devices and to distribute power to the downstream devices.

The processing system 700 may also include a storage unit 712, which may include a mass storage unit such as a solid state drive, a hard disk drive, a magnetic disk drive and/or an optical disk drive. In some examples, the storage unit 712 may store the table 200A or 200B and/or the role-based power allocation policy (e.g., the role-based power allocation policy 610) formed in the data structure 150. In other possible configurations, the storage unit 712 may store a first IP address of a first server, such as a first server 130 as shown in FIG. 1A, that maintains the table 200A such that the G2 device 102 can access the table 200A in accordance with the first IP address. In some applications, the storage unit 712 may also store a second IP address of a second server, such as a second server 160 as shown in FIG. 1A, that saves the role-based power allocation policy in the data structure 150. In such case, the G2 device 102 could access the role-based power allocation policy in accordance with the second IP address. It is noted that although the first and second server are illustrated as separate servers to store maintain the table 200A or 200B and the data structure 150, this is only illustrative and is not intended to be limiting. In other examples, the first and second server 130, 160 may be one and the same.

The processing system 700 may also include an instruction memory 714, which may include a volatile or non-volatile memory (e.g., a flash memory, a random-access memory (RAM), a read-only memory (ROM), an erasable programmable ROM (EPROM), an electrically erasable programmable ROM (EEPROM), a flash memory and a CD-ROM, to name a few non-limiting possibilities). The instruction memory 714 may store instructions for execution by the processor 704, such as to carry out example methods described in the present disclosure. The instruction memory 714 may store other software, such as an operating system and other applications/functions.

Additional components may be provided. For example, a voltameter 722 may be included in the processing system 700 to detect how much current is passed from the power source 702 in a measured time and then the processor 704 could calculate how much power in the power source 702 has been utilized by integrating the detected current over the measured time. In addition, the I/O interface 706 enables the G2 device 102 to interface with a user (e.g., an operator or an administrator of the DPN 100, 500, 600) via an input and/or output device 716, 718, such as a display, keyboard, mouse, touchscreen and/or haptic module, for example. In FIG. 7A, the input and output device 716, 718 are shown as external to the processing system 700. This is not intended to be limiting. In other examples, the input device 718 and the output device 716 may be integrated together and/or with the processing system 700. For example, the input device 718 and the output device 716 may be integrated as a single component, which may receive and display inputs from the administrator of the DPN, such as entries of the table 200A or 200B.

There may be a bus 710 providing communication among components of the processing system 700, including the power source 702, processor 704, input/output interface 706, downstream port 708, storage unit 712, and/or instruction memory 714. The bus 710 may be any suitable bus architecture including, for example, a memory bus, a peripheral bus or a video bus.

FIG. 7B is a block diagram illustrating components of a processing system 700 implementing the G2 device 102 as a G2 PCE. Components of the G2 device 102 as shown in FIG. 7B are similar to those of the G2 device 102 of FIG. 7A except that the power source 702 and the voltameter 722 are removed and an upstream port 720 is added. The upstream port 720 controlled by the I/O interface 706, via the bus 710, enables the G2 device 102 to send a power request to and receive power from a legacy PSE 110 or other power source. It is noted that the upstream port 702 is a bidirectional port which enables interconnections between the G2 device 102 and the legacy PSE 110. The “upstream” disclosed here means that the port 702 is a port that is interconnected with devices in an upstream direction relative to the G2 device 102. Similarly, the downstream port 708 is also a bidirectional port which enables interconnections between the G2 device 102 and the downstream devices 104(1)-104(8). The “downstream” disclosed here means that the port 708 is a port that is interconnected with devices in a downstream direction relative to the G2 device 102.

It is noted that FIGS. 7A and 7B are example block diagrams of components of the G2 device 102. However, different configurations and components of the G2 device 102 are possible and the disclosure is not limited to a particular configuration. Also, although FIGS. 7A and 7B show a single instance of each component, there may be multiple instances of each component in an actual implementation of the G2 device 102.

In accordance with the foregoing, the present disclosure depicts a method of allocating power based on a role-based power allocation policy, which enables certain roles to be prioritized with power allocation in the case where a power budget is insufficient to power all the devices in a DPN. Thus, power allocation to some devices with certain roles may be prioritized because those roles have higher priority levels. Compared with conventional manners of allocating power based on the device type, such application may help to allocate power with more intelligence and flexibilities for an administrator's point of view.

The flowcharts and block diagrams illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved.

The descriptions of the various embodiments of the present disclosure have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It should be appreciated that throughout the specification, discussions utilizing terms such as “processing”, “computing”, “calculating”, “determining”, “analyzing” or the like, can refer to the action and/or processes of a computer or computing system, or similar electronic computing device, that manipulate and/or transform data represented as physical, such as electronic, quantities into other data similarly represented as physical quantities.

As used herein, unless otherwise specified, the use of the ordinal adjectives “first”, “second”, “third”, etc., to describe a common object or step, merely indicate that different instances of like objects or steps are being referred to, and are not intended to imply that the objects or steps so described must be in a given sequence, either temporally, spatially, in ranking, or in any other manner.

It is noted that various individual features may be described only in the context of one embodiment. The particular choice for description herein with regard to a single embodiment is not to be taken as a limitation that the particular feature is only applicable to the embodiment in which it is described. Various features described in the context of one embodiment described herein may be equally applicable to, additive, or interchangeable with other embodiments described herein, and in various combinations, groupings or arrangements. In particular, use of a single reference numeral herein to illustrate, define, or describe a particular feature does not mean that the feature cannot be associated or equated to another feature in another drawing figure or description.

Also, when the phrase “at least one of A and B” is used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles and modes of operation of certain embodiments. However, these embodiments should not be considered limiting. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, certain technical solutions of the present disclosure may be embodied in the form of a software product. A suitable software product may be stored in a pre-recorded storage device or other similar non-volatile or non-transitory computer readable medium, for example. The software product includes instructions tangibly stored thereon that enable a processing device (e.g., a microprocessor) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

Although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method, performed at an upstream device of a data and power network (DPN) that includes at least one downstream device, for allocating power to a given downstream device of the at least one downstream device, the method comprising:
ascertaining a given role for the given downstream device, wherein the given role corresponds to a function within the DPN that has been selectively associated with the given downstream device;
allocating an amount of power to the given downstream device by applying a role-based power allocation policy; and
causing the allocated amount of power to be distributed to the given downstream device.

2. The method defined in claim 1, wherein the role-based power allocation policy defines a collection of rules for prioritizing a plurality of roles and a power allocation algorithm, the plurality of roles including the given role.

3. The method defined in claim 2, wherein the collection of rules specifies a hard-coded prioritization of the roles.

4. The method defined in claim 2, wherein the collection of rules specifies constraints for prioritization of the roles relative to one another.

5. The method defined in claim 2, wherein the collection of rules specifies at least one contextual factor on which prioritization of the roles depends.

6. The method defined in claim 5, wherein the at least one contextual factor includes a temporal factor.

7. The method defined in claim 5, wherein the at least one contextual factor includes sensed data.

8. The method defined in claim 1, further comprising retrieving the role-based power allocation policy from a non-transitory memory of the upstream device.

9. The method defined in claim 1, further comprising receiving the role-based power allocation policy from another device in the DPN via a policy discovery protocol.

10. The method defined in claim 2, wherein applying the role-based power allocation policy comprises prioritizing the plurality of roles in accordance with the collection of rules and carrying out the power allocation algorithm based on power needs of the given downstream device and on the plurality of roles as prioritized.

11. The method defined in claim 10, further comprising determining the power needs of the given downstream device.

12. The method defined in claim 11, further comprising ascertaining a device type of the given downstream device, wherein the device type differs from the given role, and wherein determining the power needs of the given downstream device is based on at least the device type.

13. The method defined in claim 12, wherein the device type corresponds to a predetermined behavior of the given downstream device independent of the DPN.

14. The method defined in claim 12, wherein the given role for the given downstream device is different from a role for another downstream device having the same device type as the device type of the given downstream device.

15. The method defined in claim 12, wherein ascertaining the device type of the given downstream device comprises determining a device identifier (ID) associated with the given downstream device and consulting a table stored in non-transitory memory, based on the device ID.

16. The method defined in claim 15, wherein ascertaining the given role for the given downstream device comprises consulting a table stored in non-transitory memory based on the device ID associated with the given downstream device.

17. The method defined in claim 16, wherein the given role for the given downstream device is independent of the device type of the given downstream device.

18. The method defined in claim 16, wherein the given role for the given downstream device is set by an administrator of the DPN.

19. The method defined in claim 1, wherein ascertaining the given role for the given downstream device is based on at least one contextual factor.

20. The method defined in claim 19, wherein the given role for the given downstream device is selected form a plurality of potential roles based on the at least one contextual factor.

21. The method defined in claim 1, wherein the ascertaining a given role for the given downstream device comprises:
determining a plurality of potential roles associated with given downstream device;
determining a contextual factor associated with the given downstream device; and
selecting the given role as a current role amongst the plurality of potential roles based on the determined contextual factor.

22. The method defined in claim 1, further comprising: receiving a power request from the given downstream device.

23. The method defined in claim 22, further comprising:
determining if the power request includes an indicator that the given downstream device is in a power domain, wherein the power domain is managed by a power sourcing device which has capability to make power allocation decisions; and
in response to the power request including the indicator, skipping allocating the amount of power to the given downstream device.

24. The method defined in claim 1, further comprising:
determining that the given downstream device has the ability to implement the role-based power allocation policy to allocate power to one or more devices in a downstream direction of the given downstream device;
obtaining respective minimum operating power of each of the one or more devices in the downstream direction of the given downstream device and minimum operating power for the given downstream device; and
allocating total minimum operating power to the given downstream device to enable the given downstream device to implement the role-based power allocation policy.

25. The method defined in claim 1, further comprising:
determining that power available to the upstream device is insufficient to meet power needs of the at least one downstream device.

26. The method defined in claim 1, wherein the role-based power allocation policy is pre-set by an administrator.

27. The method defined in claim 1, wherein the upstream device is a power sourcing equipment (PSE).

28. The method defined in claim 1, wherein the upstream device is a power consuming equipment (PCE) and wherein the method further comprises:
sending a power request to a legacy power sourcing equipment (PSE), wherein the power request indicates that an amount of power is required from the legacy PSE to power the at least one downstream device; and
receiving the power from the legacy PSE.

29. The method defined in claim 1, wherein the role-based power allocation policy includes at least a first sub-policy that defines a first collection of rules for a first contextual factor, a second sub-policy that defines a second collection of rules for a second contextual factor, and a metarule governing when each of the first sub-policy and the second sub-policy applies.

30. (canceled)

31. An upstream device of a data and power network (DPN) that includes at least one downstream device, which is configured to allocate power to a given downstream device of the at least one downstream device, the upstream device comprising:
a non-transitory memory comprising instructions; and
one or more processors in communication with the memory, wherein the one or more processors execute the instructions to:
ascertain a given role for the given downstream device, wherein the given role corresponds to a function within the DPN that has been selectively associated with the given downstream device;
allocate an amount of power to the given downstream device by applying a role-based power allocation policy; and
cause the allocated amount of power to be distributed to the given downstream device.

32.-61. (canceled)

62. A non-transitory computer readable medium having instructions tangibly stored thereon, wherein the instructions, when executed, cause a system to perform the method of claim 1.
